(19) United States
(12) Patent Application Publication
(10) Pub. No.: US 2024/0211674 A1
(43) Pub. Date: Jun. 27, 2024

(54) INTEGRATED-CIRCUIT DESIGN METHODS

(71) Applicant: Nordic Semiconductor ASA, Trondheim (NO)

(72) Inventors: Johnny PIHL, Trondheim (NO); Ciro CORCELLI, Trondheim (NO)

(73) Assignee: Nordic Semiconductor ASA, Trondheim (NO)

(21) Appl. No.: 18/542,102

(22) Filed: Dec. 15, 2023

(30) Foreign Application Priority Data
Dec. 21, 2022 (GB) 2219379.1

(51) Int. Cl. G06F 30/392; G06F 30/327

(52) U.S. Cl. CPC G06F 30/392; G06F 30/327; G06F 2113/18

(57) ABSTRACT

A computer-implemented method for designing an integrated circuit includes placing a predefined cell within a twin-well CMOS silicon-on-insulator integrated circuit design. The predefined cell comprises a logic region comprising one or more transistors of a first type, the first type being either conventional-well CMOS transistors or flipped-well CMOS transistors. The predefined cell also comprises an inner set of boundary cells that are arranged along one or more edges of the logic region, and an outer set of boundary cells that are arranged along one or more edges of the predefined cell and that are configured for placement adjacent transistors of a second type, the second type being either flipped-well CMOS transistors or conventional-well CMOS transistors and the second type being different from the first type.

### CROSS REFERENCE TO RELATED APPLICATION

This application claims priority to Great Britain Application No. 2219379.1, filed Dec. 21, 2022, which application is incorporated herein by reference in its entirety.

### TECHNICAL FIELD

The invention relates to computer-implemented methods and software for designing integrated circuits and to resulting integrated circuit (IC) designs and devices.

### BACKGROUND

Silicon-on-insulator IC chips use layered silicon-insulator-silicon substrates to provide low parasitic capacitance and current leakage in their transistors. This enables N-type metal-oxide-semiconductor (NMOS) and P-type metal-oxide-semiconductor (PMOS) transistors to be formed in close proximity on an insulating substrate (e.g. sapphire) when using twin-well complementary metal-oxide-semiconductor (CMOS) silicon-on-insulator technology.

Twin-well silicon-on-insulator process technologies can support both conventional-well CMOS transistors (i.e. transistors having P wells under N+ doped source and drain terminals, and N wells under P+ doped source and drain terminals) and flipped-well CMOS transistors (i.e. transistors having N wells under N+ doped source and drain terminals, and P wells under P+ doped source and drain terminals). The GF22N process from Global Foundries is an example of such process technology. Typically flipped-well transistors are able to have a lower threshold voltage (V_{T}) than conventional-well transistors, and so can support faster switching but have a higher standby or leakage power consumption than conventional-well transistors.

When designing ICs for low-power applications (e.g. battery-powered sensors), low leakage is essential to reduce power consumption, especially for circuitry that remains active during standby. However, high performance may also be required at times (e.g. when transmitting radio data), and so a twin-well CMOS silicon-on-insulator IC design may include one or more regions of flipped-well transistors (e.g. for speed-critical circuitry that is used when the IC is in an active state), as well as one or more regions of conventional-well transistor (e.g. for power-efficient standby circuitry).

Complex ICs are typically designed with the assistance of automated synthesis and place-and-route software tools, as part of an electronic design automation (EDA) process. Place-and-route tools can access standard cells (e.g. basic Boolean logic blocks) from a cell library and can determine where to place them optimally in the IC design. However, placing conventional-well devices and flipped-well devices in the same design requires careful manual input in order to ensure that the transistors of each type are sufficiently grouped and separated in different respective regions so that the design can be reliably manufactured by a foundry (i.e. to ensure the design satisfies design rules). Such manual input can be very time consuming. It may also result in less optimal designs overall.

Embodiments of the present invention seek to provide a different approach.

### SUMMARY OF THE INVENTION

When viewed from a first aspect, the invention provides a computer-implemented method for designing an integrated circuit, the method comprising:
placing a predefined cell within a twin-well CMOS silicon-on-insulator integrated circuit design, wherein the predefined cell comprises:
a logic region comprising one or more transistors of a first type, the first type being either conventional-well CMOS transistors or flipped-well CMOS transistors;
an inner set of boundary cells that are arranged along one or more edges of the logic region; and
an outer set of boundary cells that are arranged along one or more edges of the predefined cell and that are configured for placement adjacent transistors of a second type, the second type being either flipped-well CMOS transistors or conventional-well CMOS transistors and the second type being different from the first type.

When viewed from a second aspect, the invention provides computer software for designing an integrated circuit comprising instructions that, when executed by a processor, cause the processor to:
place a predefined cell within a twin-well CMOS silicon-on-insulator integrated circuit design,
wherein the predefined cell comprises:
   a logic region comprising one or more transistors of a first type, the first type being either conventional-well CMOS transistors or flipped-well CMOS transistors;
   an inner set of boundary cells that are arranged along one or more edges of the logic region; and
   an outer set of boundary cells that are arranged along one or more edges of the predefined cell and that are configured for placement adjacent transistors of a second type, the second type being either flipped-well CMOS transistors or conventional-well CMOS transistors and the second type being different from the first type.

When viewed from a third aspect, the invention provides a computer-readable medium storing data that represents a predefined cell for a twin-well CMOS silicon-on-insulator integrated circuit design, wherein the predefined cell comprises:
a logic region comprising one or more transistors of a first type, the first type being either conventional-well CMOS transistors or flipped-well CMOS transistors;
an inner set of boundary cells that are arranged along one or more edges of the logic region; and
an outer set of boundary cells that are arranged along one or more edges of the predefined cell and that are configured for placement adjacent transistors of a second type, the second type being either flipped-well CMOS transistors or conventional-well CMOS transistors and the second type being different from the first type.

When viewed from a fourth aspect, the invention provides a computer-readable medium storing data that represents a twin-well CMOS silicon-on-insulator integrated circuit design comprising a predefined cell, wherein the predefined cell comprises:
a logic region comprising one or more transistors of a first type, the first type being either conventional-well CMOS transistors or flipped-well CMOS transistors;
an inner set of boundary cells that are arranged along one or more edges of the logic region; and
an outer set of boundary cells that are arranged along one or more edges of the predefined cell and that are configured for placement adjacent transistors of a second type, the second type being either flipped-well CMOS transistors or conventional-well CMOS transistors and the second type being different from the first type.

When viewed from a fifth aspect, the invention provides a twin-well CMOS silicon-on-insulator integrated circuit device that comprises one or more instances of a predefined cell, wherein the predefined cell comprises:
a logic region comprising one or more transistors of a first type, the first type being either conventional-well CMOS transistors or flipped-well CMOS transistors;
an inner set of boundary cells that are arranged along one or more edges of the logic region; and
an outer set of boundary cells that are arranged along one or more edges of the cell and that are configured for placement adjacent transistors of a second type, the second type being either flipped-well CMOS transistors or conventional-well CMOS transistors and the second type being different from the first type.

Thus it will be seen that, in accordance with embodiments of the invention, a predefined cell is provided that can be safely placed in a region of transistors that are of a different twin-well type from the transistors of the predefined cell without this necessarily causing a design rule violation. The cell achieves this by providing two layers of boundary cells that can separate the cell's own transistors from transistors outside the cell, so as to comply with any design rules. Providing these two sets of boundary cells within the predefined cell itself can allow instances of the predefined cell to be placed by automated place-and-route tools without the need for manual boundaries to be drawn, thereby enabling an efficient design process.

In one set of embodiments, the one or more transistors in the logic region (i.e. the logic region of the predefined cell) are conventional-well CMOS transistors, and the outer set of boundary cells are configured for placement adjacent flipped-well CMOS transistors (e.g. being configured for providing well termination structure for the logic region). This can conveniently enable a power-efficient component (e.g. a buffer), provided by the predefined cell, to be placed within a region of faster but less power-efficient flipped-well devices. This may be useful for enabling the chip still to perform a background task while the rest of the region is in a low-power (e.g. standby) state. By enabling the automated insertion of low-leakage digital cells into high-speed dominated areas, embodiments can provide an efficient way to implement low-leakage standby circuitry in high-speed dominated areas of the IC.

The inner set may contain any number of boundary cells. The boundary cells of the inner set may be arranged along at least two edges of the logic region, e.g. two opposite edges. The boundary cells of the inner set may be arranged at least along every vertical edge of the logic region, and may be arranged along every edge of the logic region. They may form a border around a perimeter of the logic region, which may be a continuous border (with or without corner boundary cells). Thus they may fully enclose the logic region. The continuous border may, in some embodiments, include a boundary cell at each corner of the border, although this may not be the case in some embodiments. The inner set may comprise one or more end row boundary cells and/or one or more end column boundary cells and/or one or more corner boundary cells. The end row and/or end column boundary cells of the inner set may have a type that matches the respective edge of the logic region outside of which they are located—e.g. left end row boundary cells located outside a left edge of the logic region, right end row boundary cells located outside a right edge of the logic region outside, upper end column boundary cells located outside an upper edge of the logic region, and/or lower end column boundary cells located outside a lower edge of the logic region. The corner boundary cells of the inner set may comprise outer corner boundary cells. The boundary cells of the inner set may be physical-only cells (i.e. having no signal connectivity).

The outer set may contain any number of boundary cells. The boundary cells of the outer set may be arranged along at least two edges of the predefined cell, e.g. two opposite edges. The boundary cells of the outer set may be arranged at least along every vertical edge of the cell, and may be arranged along every edge of the cell. They may form a border around a perimeter of the predefined cell, which may be a continuous border (with or without corner boundary cells). Thus they may fully enclose both the logic region and the inner set of boundary cells. The continuous border may, in some embodiments, include a boundary cell at each corner of the border, although this may not be the case in some embodiments. The outer set may comprise one or more end row boundary cells and/or one or more end column boundary cells and/or one or more corner boundary cells. The end row and/or end column boundary cells of the outer set may have a type that opposes the respective edge of the logic region outside of which they are located—e.g. left end row boundary cells located outside a right edge of the logic region, right end row boundary cells located outside a left edge of the logic region, upper end row boundary cells located outside a lower edge of the logic region and/or lower end row boundary cells located outside an upper edge of the logic region. The corner boundary cells of the outer set may comprise inner corner boundary cells. The boundary cells of the outer set may be physical-only cells (i.e. having no signal connectivity).

Each boundary cell of the outer set may be separated from the logic region by at least one respective boundary cell of the inner set. In some embodiments, the boundary cells of the outer set may fully enclose the inner set of boundary cells, and the inner set of boundary cells may fully enclose the logic region. The inner set of boundary cells may serve to isolate the logic region of the predefined cell from a second logic region in which it is located, and the outer set of boundary cells may serve to isolate the second logic region from the logic region of the predefined cell located therein.

The predefined cell may comprise (i.e. defines) a spacing region arranged between the inner set of boundary cells and the outer set of boundary cells. The spacing region may define a region of undoped substrate. The spacing region may have no power or signal connectivity. Each boundary cell of the outer set may be separated from every boundary cell of the inner set by a respective portion of the spacing region. The spacing region may be a single continuous region. It may fully enclose (i.e. surround) the logic region and the inner set of boundary cells. It may separate each boundary cell of the inner set from a closest boundary cell of the outer set by a distance defined in accordance with a deep n- or p-well spacing requirement. In some embodiments it may separate each boundary cell of the inner set from a closest boundary cell of the outer set by exactly one row (if the closest outer boundary cell is above or below the inner boundary cell) or one column (if the closest outer boundary cell is left or right of the inner boundary cell). The provision of a spacing region may further assist in avoiding design rule errors when the design is checked.

The boundary cells of the inner set may differ from the boundary cells of the outer set. They may be configured for placement adjacent transistors of the first type.

At least one of the transistors in the logic region may abut a respective boundary cell of the inner set.

The predefined cell may be rectangular. This may facilitate placement of the cell in the design.

The predefined cell may be stored in a cell library database—e.g. within a memory of a computer device such as a server or workstation. The predefined cell may be retrieved from a cell library database. The predefined cell may be a library cell. It may be or comprise data that encodes relative positions of the one or more transistors and of the inner and outer sets of the boundary cells within the predefined cell. It may comprise or be associated with data representing details (e.g. layers) of the one or more transistors and the boundary cells. Placing the predefined cell in the design may comprise determining a position for the predefined cell in the design (e.g. within a two-dimensional floorplan). A plurality of instance of the predefined cell may be placed within the integrated circuit design. This can lead to particular design efficiencies, e.g. compared with having to manually design and place multiple regions containing different transistor types in a design.

Some embodiments may comprise placing a second predefined cell comprising a second logic region comprising one or more transistors of the first type, arranged differently from the one or more transistors of the logic region of the aforesaid predefined cell (e.g. for performing a different logic function), and comprising a second inner set of boundary cells along one or more edges of the second logic region, and a second outer set of boundary cells arranged along one or more edges of the second predefined cell and configured for placement adjacent transistors of the second type.

Methods or software disclosed herein may place any number of other library cells, e.g. retrieved from a same cell library as the predefined cell.

Methods or software disclosed herein may generate a placed-gates netlist, which they may output or store in a memory.

The predefined cell may be placed within a region that is designated for transistors of the second type. The IC design or device may comprise at least one transistor of the second type that abuts a respective boundary cell of the outer set. The predefined cell may be placed as an independent power domain, different from a power domain within which the predefined cell is placed. This may allow the predefined cell to be powered independently from the region in which it is placed.

The logic region may be rectangular, although this is not essential. It may occupy one or more rows and one or more columns of an underlying site array used by the software. It may occupy a plurality of rows and a single column, a plurality of columns and a single row, or a plurality of rows and a plurality of columns. The logic region may contain only transistors of the first type (i.e. no transistors that are not of the first type). The logic region may contain only digital logic (i.e. no analog circuitry). The one or more transistors may be arranged to perform one or more Boolean logic functions (e.g. AND, OR, NOT, etc.), or to provide one or more flip-flops, latches or buffers. The predefined cell may be arranged to perform one or more Boolean logic functions, or to provide one or more flip-flops, latches or buffers. In one particular embodiment, the one or more transistors provide a multi-bit flip-flop. This may increase the flexibility of the predefined cell by enabling it to be used in many different types of circuit.

Methods disclosed herein may be placement methods. They may be place-and-route methods. They may be electronic design automation (EDA) methods. Some embodiments may comprise performing routing and/or other design operations on the integrated circuit design. They may comprise verifying the design according to a set of design rules are a series of parameters provided by semiconductor manufacturers that enable the designer to verify the correctness of a mask set. The methods may comprise manufacturing an integrated circuit device designed using a method disclosed herein, although this is not essential.

From one aspect, the invention provides an integrated circuit device manufactured in accordance with a twin-well CMOS silicon-on-insulator integrated circuit design produced using a method as disclosed herein.

Software disclosed herein may be a routing tool. It may be a place-and-route tool. It may be electronic design automation (EDA) software. It may comprise instructions for performing routing and/or other design operations on the integrated circuit design. The software may be stored on a non-transitory computer-readable storage medium. It may be stored in a memory of a computer system, which may comprise a processor for executing the instructions of the computer software. The software may comprise instructions for accessing a cell library database. It may comprise instructions for storing data representative of the IC design after placement of the predefined cell (and optionally other library cells) in a memory.

From one aspect, the invention provides a computer system (e.g. an EDA system) configured to perform a method as disclosed herein. It may comprise a processor and a memory storing computer software as disclosed herein.

An IC device as disclosed herein may be a system-on-chip (SoC). It may comprise radio transceiver circuitry.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments of the invention will now be described, by way of example only, with reference to the accompanying drawings, in which:

FIG. 1a is a schematic cross-sectional diagram of a conventional-well silicon-on-insulator CMOS transistor;

FIG. 1b is a schematic cross-sectional diagram of a flipped-well silicon-on-insulator CMOS transistor;

FIG. 2 is a schematic plan-view diagram of a part of a twin-well silicon-on-insulator IC design;

FIG. 3 is a schematic plan-view diagram of a region of a twin-well silicon-on-insulator IC design, designed in accordance with embodiments of the invention.

### DETAILED DESCRIPTION

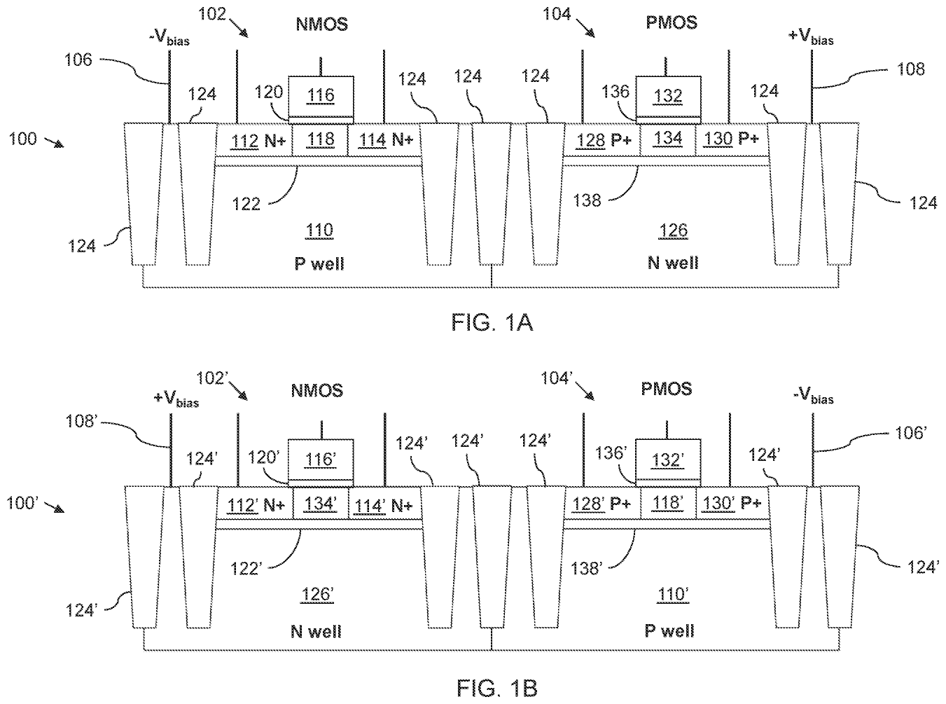

FIG. 1a shows a conventional-well silicon-on-insulator twin-well CMOS transistor 100 (hereinafter referred to as a conventional CMOS 100). FIG. 1b shows a flipped-well silicon-on-insulator twin-well CMOS transistor 100′ (hereinafter referred to as a flipped CMOS 100′).

The conventional CMOS 100 comprises an N-type metal-oxide-semiconductor field-effect transistor (NMOS) 102 and a P-type metal-oxide-semiconductor field-effect transistor (PMOS) 104, connected as a symmetric pair between a negative bias terminal 106 and a positive bias terminal 108. In use, the negative bias terminal 106 is provided with a negative bias voltage −V_{bias} the positive bias terminal 108 is provided with a positive bias voltage +V_{bias}. It will be appreciated that these bias voltages are technology dependent and therefore may take, in use, any appropriate range of values e.g. 0 to ±2V, ±5V, etc. It will also be appreciated that these bias voltages need not be symmetric, and that depending on application the conventional CMOS 100 could be reversed bias (e.g. where the negative bias terminal 106 is fed with a positive bias voltage +V_{bias} and the positive bias terminal 108 is fed with a negative bias voltage −V_{bias}.

The NMOS 102 comprises a lightly doped P-type silicon substrate 110 (hereinafter referred to as the P well 110), an N+ source terminal 112, an N+drain terminal 114, a gate terminal 116, a body 118, a gate oxide layer 120, and a buried-oxide insulator layer 122. In this example, the source terminal 112 and the drain terminal 114 are formed of highly N+ doped silicon, the gate terminal 116 is formed of polysilicon, and the body 118 is formed of lightly doped P-type silicon (i.e. the same or similar material to the P well 110) or from fully depleted silicon (e.g. when using fully-depleted silicon on insulator (FD-SOI) technology). Shallow-trench-isolation (STI) regions 124 are provided to separate different parts of the NMOS 102 and PMOS 104. The NMOS 102 gate oxide layer 120, the insulator layer 122 and the STI regions 124 are each formed of dielectric insulating material, e.g. silicon oxide. The negative bias terminal 106 is electrically coupled to the P well 110 of the NMOS 102.

The PMOS 104 comprises a lightly doped N-type silicon substrate 126 (hereinafter referred to as the N well 126), a P+ source terminal 128, a P+ drain terminal 130, a gate terminal 132, a body 134, a gate oxide layer 136, and an insulator layer 138. In this example, the source terminal 128 and the drain terminal 130 are formed of highly P+ doped silicon, the gate terminal 132 is formed of polysilicon, and the body 134 is formed of lightly doped N-type silicon (i.e. similar material to the N well 126) or from fully depleted silicon. The gate oxide layer 120 and the insulator layer 122 are formed of dielectric insulating material, e.g. silicon oxide. The positive bias terminal 108 is electrically coupled to the N well 126 of the PMOS 104.

Thus it, in the conventional CMOS 100, the NMOS 102 comprises a P well 110 under N+ doped source and drain terminals 112, 114 (separated from the P well 110 by the insulator layer 122), and the PMOS 104 comprises an N well 126 under P+ doped source and drain terminals 128, 130 (separated from the N well 126 by the insulator layer 138).

The flipped CMOS 100′ has a similar structure to the conventional CMOS 100, where like reference numerals with primes are used to indicate regions and terminals formed of the same materials. However, the flipped CMOS 100′ differs from the conventional CMOS 100 in that the NMOS 102′ comprises an N well 126′ and the PMOS 104′ comprises an P well 110′, and the body 134′ of the NMOS 102′ is formed of lightly doped N-type silicon or fully depleted silicon, while the body 118′ of the PMOS 104′ is formed of lightly doped P-type silicon or is fully depleted.

Thus, in the flipped CMOS 100′, the NMOS 102′ comprises an N well 126′ under N+ doped source and drain terminals 112′, 114′ (separated from the N well 126′ by the insulator layer 122′), and the PMOS 104′ comprises a P well 110′ under P+ doped source and drain terminals 128′, 130′ (separated from the P well by the insulator layer 138′).

Both the conventional CMOS 100 and the flipped CMOS 100′ provide lower power consumption, high temperature stability (in part due to increased current load balance), high noise tolerance, and other inherent advantages of CMOS technology. Additionally, both the conventional CMOS 100 and the flipped CMOS 100′ provide the advantages of silicon-on-insulator technology, including reduced current leakage (and therefore reduced power consumption) into the well, reduced parasitic capacitance, greater isolation from power supply noise, etc.

The conventional CMOS 100 has a higher threshold voltage V_{T} than the flipped CMOS 100′, due to the contrasting doping types between the source and drain terminals 112, 113, 128, 130 and the wells 110, 126 located thereunder. As a result of this greater V_{T}, the conventional CMOS 100 advantageously exhibits lower levels of current leakage (and therefore lower power consumption) than the flipped CMOS 100′, at a trade-off of slower switching speed (and therefore slower logic speed). Accordingly, as a result of its lower V_{T}, the flipped CMOS 100′ advantageously exhibits a faster switching speed than the conventional CMOS 100 (and therefore faster logic speed), at a trade-off of greater current leakage (and therefore greater power consumption).

Thus, the conventional CMOS 100 is particularly suitable for applications where power consumption is of greater concern than logic speed, particularly in battery-powered devices, including stand-by circuitry, random access memory (RAM) with intention functionality, etc., whereas the flipped CMOS 100′ is particularly suitable for applications where logic speed is of greater concern than power consumption, e.g. time-critical logic operations.

Additionally, the threshold voltages V_{T} of both the conventional CMOS 100 and the flipped CMOS 100′ are adjustable by altering the bias voltages applied to their respective bias terminals 106, 108, 106′, 108′. For example, the conventional CMOS 100 can be reverse biased in order to increase its threshold voltage V_{T}, thereby reducing leakage thereof at the expense of reduced logic speed. Similarly, the flipped CMOS 100′ can be forward biased in order to reduce its threshold voltage V_{T}, thereby increasing logic speed at the expense of increase leakage.

Place-and-route tools are software programs which receive a circuit design as input (e.g. in the form of a synthesis netlist), and that generate a physical chip layout for verification and subsequent implementation in a target technology. The placement process determines where the components should be located on a floorplan of the chip, and then a routing process optimises the interconnections between the components. A place-and-route tool may optimise the layout in terms of parameters such as silicon area, power consumption, logic speed, temperature requirements, etc.

Place-and-route tools retrieve standard cells with specific logic functions (e.g. NAND cells, buffers, inverters or NOT cells, etc.) from a cell library, which are placed and connected together in a grid-like structure. Cells can be arranged along rows with the same well material (P or N) extending along the rows spanning multiple transistors. Transistors are laid out according to requirements specified by a foundry in order to automatically generate a physical chip design that can be manufactured by that foundry. Each standard cell may comprise a plurality of CMOS transistors with a predefined layout in order to implement a desired logic function.

Place-and-route tools can operate fully independently in order to generate IC chip layouts, but they can also receive input from a human designer in order to develop a final chip layout for manufacture. It is rare for a complex digital IC chip (e.g. a system-on-chip) layout to be generated without at least some involvement from a place-and-route tool in view of the very high numbers of cells/transistors included in many IC chips.

Foundries have requirements on chip designs that they can manufacture, based on physical limitations of the equipment available, in order to ensure that manufactured chips function consistently. These requirements will depend on the processes used by a particular foundry, e.g. the process node number.

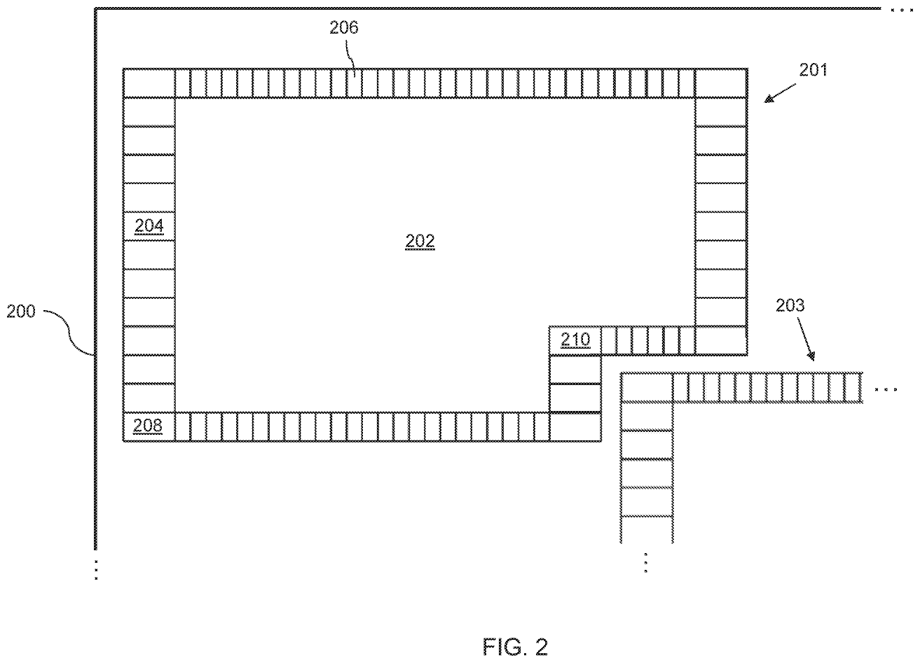

FIG. 2 is a plan view of part of an exemplary design of a twin-well silicon-on-insulator IC chip 200, generated using a place-and-route tool that may embody the invention.

With twin-well silicon-on-insulator technology, chips can be divided into distinct and physically separated areas, like the first area 201 and second area 203, that may be respectively designated for containing either conventional CMOS 100 cell or flipped CMOS 100′ cells. The need for physical separation arises because, as can be seen from FIG. 1, the overall structure of conventional CMOS 100 and flipped CMOS 100′ differs significantly such that devices with non-alike well types cannot be formed adjacent each other, but must be separated by physical-only boundary cells. Each area is therefore designated for a single type of CMOS, in dependence on the overall operating requirements for that area. Thus, conventionally, a balance needs to be struck between speed and standby power consumption in order to determine whether to designate a particular area for conventional CMOS 100, or for flipped CMOS 100′. If speed is generally of greater concern than power consumption for a particular subsystem, then an area of flipped CMOS 100′ is typically designated for the area of silicon designated for that subsystem. Conversely, if standby power consumption is of greater concern, then an area of conventional CMOS 100 is typically designated for the area of silicon designated for that subsystem.

In the example in FIG. 2, the first area 201 has been designated for flipped CMOS 100′, while the second area 203 has been designated for conventional CMOS 100. However, it will be appreciated that the first area 201 could equally be an area of silicon designated for conventional CMOS 100. The first area 201 comprises a logic region 202 in which standard cells (i.e. predefined cells, retrieved from a cell library database, for performing particular digital logic functions) can be placed by the place-and-route tool.

The area 201 is divided into rows and columns, such that a line of wells with a common doping (e.g. N wells and P wells) can be formed as a continuous band along each row within the area 201. Each row is effectively divided into two sub-rows—one providing a line of N wells and one providing a line of P wells—with a transistor on a row having one well in the first sub-row and another in the second sub-row. Each row has the opposite N well/P well configuration to its vertically adjacent row, such that an N well sub-row of a given row is adjacent to the N well sub-row of the adjacent row. This arrangement in rows provides for easier and more space-efficient manufacturing by a foundry, as well as being a convenient mechanism for systematic design of the chip layout by the place and route tool. Standard cells typically occupy one or two rows in height, although they may be larger.

The logic region 202 is fully enclosed by a set of boundary cells 204, 206, 208, 210. In this example there are four different types of boundary cell: end row boundary cells 204, end column boundary cells 206, outer corner boundary cells 208 and inner corner boundary cells 210. These boundary cells occupy area on the silicon, but are physical-only cells—i.e. they provide no logic functionality. Their purpose is to physically separate the logic region 202 from other areas of a chip, such as the second area 203, in order to make it physically possible to manufacture the chip reliably by ensuring the design satisfy the foundry's well tie-off requirements. The exact designs of the different boundary cells will depend on the technology that will be used to fabricate the chip. Typically, in twin-well silicon-on-insulator (SOI) processes, row, column and corner boundary cells would be provided, although in some instances, depending on manufacturing processes, column boundary cells and/or corner boundary cells may not necessarily be required and in such cases it's possible that the boundary cells need not fully enclose the logic region (e.g. consisting only of two columns of end row boundary cells).

The enclosure of the logic region 202 by the boundary cells 204, 206, 208, 210 also enables the region 202 to operate as an independent power domain—i.e. where the region 202 can be selectively provided with power independently of other areas of the chip, such as the second area 203. This can allow an area 201, 203 to be switched into a low-power standby state at times, in order to save power consumption for the chip 200 as a whole.

Although dividing chips into distinct areas 201, 203 offers some flexibility with regard to balancing logic speed and power consumption, it still requires a single selection of either conventional CMOS 100 or flipped CMOS 100′ to be made for an entire area 201. The applicant has realised that it would be desirable to be able to include, within an area such as the first area 202 that is designated for transistors of one well-type, some circuitry that has different speed or power-consumption requirements from the majority of the circuitry contained within that area. For example, operations which require high speed but which are not powered all the time (e.g. packet-based radio control logic) generally lend themselves to a region designated for flipped CMOS 100′, but it may also be desirable to be able to include some components (e.g. standby circuitry) that can be efficiently operated even when constantly powered. Such components would desirably be formed of conventional CMOS 100 in order to benefit from its low leakage. Conventional place-and-route tools are unable to do this automatically, and so would instead designate the whole area 201 for flipped CMOS 100′, in view of the logic speed requirements of the non-standby circuitry dominating over the power consumption benefits of using conventional CMOS 100 for the relatively smaller stand-by circuitry.

However, the novel routing methods disclosed herein can overcome this limitation by providing a way to automatically place conventional CMOS 100 transistors within a logic area 202 that is designated for flipped CMOS 100′ (and vice versa, if desired).

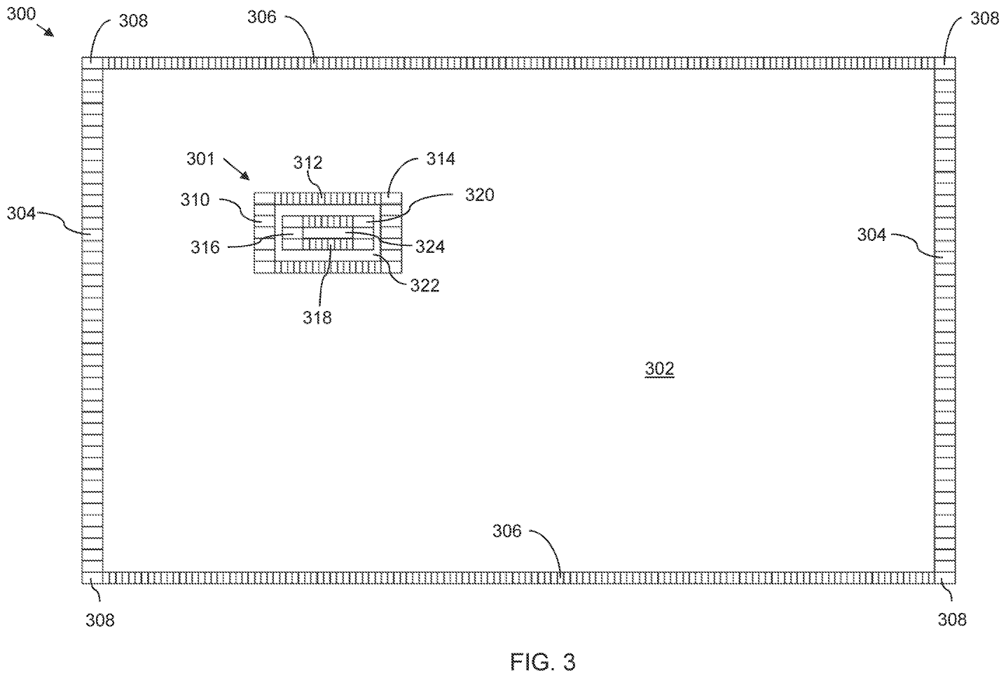

FIG. 3 shows a plan view of an exemplary area 300 of a twin-well silicon-on-insulator IC chip design, generated using a place-and-route tool in accordance with embodiments of the present invention. The area 300 comprises a logic region 302 that is designated for flipped-well CMOS 100′ devices. In this example, the flipped cell logic region 302 is rectangular and fully enclosed by outer boundary cells 304, 306, 308, which are arranged around the four edges of the rectangular region 302. There are two columns of end row boundary cells 304, two rows of flipped end column boundary cells 306, and four flipped outer corner boundary cells 308. The boundary cells 304, 306, 308 are configured for being placed next to flipped-well transistors.

The place-and-route tool is, however, configured to place a novel class of predefined cells, stored in a cell library database, which it can place within the flipped cell region 302, that the place-and-route tool can treat like a standard flipped CMOS 100′ cell, but which contains one or more conventional CMOS transistors 100. An exemplary such cell 301 is shown in FIG. 3, but the cell library may contain several different designs of such cells, having different functions (e.g. implementing different respective Boolean logic functions, or providing a buffer, flip-flop, etc.).

Such placement is possible because the library cell 301 comprises an outer ring of boundary cells 310, 312, 314 that encompasses an inner ring of boundary cells 316, 318, 320, with a spacing region 322 between the inner and outer rings, and further comprises a logic region 324 within the inner ring 316, 318, 320 that contains one or more conventional-well CMOS transistors 100. The outer ring comprises flipped-well end row boundary cells 310, flipped-well end column boundary cells 312, and flipped-well inner corner boundary cells 314. The inner ring comprises conventional-well end row boundary cells 316, conventional-well end column boundary cells 318, and conventional-well outer corner cells 320 (i.e. boundary cells configured for placement adjacent conventional-well devices).

The spacing region 322 is pure undoped substrate—i.e. it can be considered as empty space from an operational and manufacturing perspective. The conventional-well logic region 324 may contain any number of conventional-well CMOS transistors 100. In this example, the logic region 324 is shown as one row high and eight columns wide, but it could be taller and/or narrower or wider than this. The predefined cell 301 may be arranged for providing a single logical function—e.g. a NAND cell, a NOT cell, a buffer, a flip-flop, etc., which may provide flexibility on where it can be used. However, it may support more complex functions, such as the execution of a sequence of logical operations.

The outer ring 310, 312, 314 of boundary cells ensures that the remaining space for other cells within the flipped-cell region 302 is fully enclosed between this outer ring of the library cell 301 and the outer boundary cells 304, 306, 308 of the region 302. Likewise the inner ring 316, 318, 320 of boundary cells ensures that the conventional-well logic region 324 is also fully enclosed. This may help ensure the design passes design rule verification checks and meets foundry requirements which may specify that a particular cell region must be fully enclosed for reliable manufacture of a functional chip.

In some embodiments, these rings of boundary cells may also enable the logic region 324 to be configured as a different power domain from the rest of the region 302 (i.e. it can be powered independently of the logic region 302). This may be particularly beneficial where the conventional-well logic region 324 contains stand-by circuitry which is required to remain powered even when the rest of the flipped-well cell region 302 is powered off in order to reduce overall power consumption. The spacing region 322 physically separates the outer ring of flipped boundary cells 310, 312, 314 and the inner ring of conventional boundary cells 316, 318, 320, which may avoid verification failures and/or issues during manufacture and may help ensure that a chip designed using a place-and-route tool embodying the invention meets foundry requirements.

It will be appreciated that the designations of the standard cell regions 302 and 324 (and, accordingly, the outer ring of boundary cells 310, 312, 314 and the inner ring of boundary cells 316, 218, 320) shown in FIG. 3 May equally be reversed in some examples—i.e., the region 302 could be designated for conventional CMOS 100 and the region 324 could contain flipped CMOS 100′, dependent on requirements.

A place-and-route tool as described herein may be implemented as computer software stored in digital storage, such as a magnetic or solid-state hard drive, RAM or optical medium. It may be executed by a processor (which may have multiple processor cores) in a processing system such as a workstation, mainframe or server. It may be a component of an EDA tool. The system may provide a display and input devices such as a keyboard and for a human operator to control the software. The cell library database may be hosted by a same computer as executes the software or on a different computer such as a network server.

It will be appreciated by those skilled in the art that the invention has been illustrated by describing one or more specific embodiments thereof, but is not limited to these embodiments; many variations and modifications are possible, within the scope of the accompanying claims.

1. A computer-implemented method for designing an integrated circuit, the method comprising:
placing a predefined cell within a twin-well CMOS silicon-on-insulator integrated circuit design, wherein the predefined cell comprises:
a logic region comprising one or more transistors of a first type, the first type being either conventional-well CMOS transistors or flipped-well CMOS transistors;
an inner set of boundary cells that are arranged along one or more edges of the logic region; and
an outer set of boundary cells that are arranged along one or more edges of the predefined cell and that are configured for placement adjacent transistors of a second type, the second type being either flipped-well CMOS transistors or conventional-well CMOS transistors and the second type being different from the first type.

2. The computer-implemented method of claim 1, wherein the one or more transistors in the logic region are conventional-well CMOS transistors, and wherein the outer set of boundary cells are configured for placement adjacent flipped-well CMOS transistors.

3. The computer-implemented method of claim 1, wherein the boundary cells of the inner set form a continuous border around a perimeter of the logic region.

4. The computer-implemented method of claim 1, wherein the boundary cells of the outer set form a continuous border around a perimeter of the predefined cell.

5. The computer-implemented method of claim 1, wherein each boundary cell of the outer set is separated from the logic region by at least one respective boundary cell of the inner set.

6. The computer-implemented method of claim 1, wherein the predefined cell comprises a spacing region arranged between the inner set of boundary cells and the outer set of boundary cells.

7. The computer-implemented method of claim 6, wherein the spacing region is a single continuous region that fully encloses the logic region and the inner set of boundary cells.

8. The computer-implemented method of claim 1, wherein at least one of the one or more transistors in the logic region abuts a boundary cell of the inner set.

9. The computer-implemented method of claim 1, comprising retrieving the predefined cell from a cell library database.

10. The computer-implemented method of claim 1, comprising placing a plurality of instances of the predefined cell within the twin-well CMOS silicon-on-insulator integrated circuit design.

11. The computer-implemented method of claim 1, comprising generating a placed-gates netlist for the twin-well CMOS silicon-on-insulator integrated circuit design.

12. The computer-implemented method of claim 1, comprising placing the predefined cell within a region that is designated for transistors of the second type.

13. The computer-implemented method of claim 1, comprising placing the predefined cell as an independent power domain that is different from a power domain within which the predefined cell is placed.

14. The computer-implemented method of claim 1, wherein the logic region contains only a single row of one or more transistors.

15. The computer-implemented method of claim 1, wherein the logic region contains only transistors of the first type.

16. The computer-implemented method of claim 1, wherein the one or more transistors are arranged to perform a Boolean logic function or to provide a flip-flop, latch or buffer.

17. A non-transitory computer-readable medium storing computer software for designing an integrated circuit comprising instructions that, when executed by a processor, cause the processor to perform the method of claim 1.

18. A computer system comprising a processor and a memory and configured to perform the method of claim 1.

19. A non-transitory computer-readable medium storing data that represents a predefined cell for a twin-well CMOS silicon-on-insulator integrated circuit design, wherein the predefined cell comprises:
a logic region comprising one or more transistors of a first type, the first type being either conventional-well CMOS transistors or flipped-well CMOS transistors;
an inner set of boundary cells that are arranged along one or more edges of the logic region; and
an outer set of boundary cells that are arranged along one or more edges of the predefined cell and that are configured for placement adjacent transistors of a second type, the second type being either flipped-well CMOS transistors or conventional-well CMOS transistors and the second type being different from the first type.

20. A non-transitory computer-readable medium storing data that represents a twin-well CMOS silicon-on-insulator integrated circuit design comprising a predefined cell, wherein the predefined cell comprises:
a logic region comprising one or more transistors of a first type, the first type being either conventional-well CMOS transistors or flipped-well CMOS transistors;
an inner set of boundary cells that are arranged along one or more edges of the logic region; and
an outer set of boundary cells that are arranged along one or more edges of the predefined cell and that are configured for placement adjacent transistors of a second type, the second type being either flipped-well CMOS transistors or conventional-well CMOS transistors and the second type being different from the first type.
